(19) United States
(12) Patent Application Publication
(10) Pub. No.: US 2005/0244791 A1
(43) Pub. Date: Nov. 3, 2005

(54) Interproximal reduction treatment planning

(75) Inventors: Bradley A. Davis, Santa Clara, CA (US); Samuel J. Kass, Santa Clara, CA (US); Anil Kumar V. Chillarige, Milpitas, CA (US); Andrey Emeliyanenko, Moscow (RU)

Correspondence Address: ALIGN TECHNOLOGY, INC.;ATTENTION: SCOTT SMITH, 881 MARTIN AVENUE, SANTA CLARA, CA, 95050, US

(73) Assignee: ALIGN TECHNOLOGY, INC., Santa Clara, CA (US)

(21) Appl. No.: 10/836,733

(22) Filed: Apr. 29, 2004

(51) Int. Cl. A61C 11/00; A61C 3/00

(52) U.S. Cl. 433/213; 433/24

(57) ABSTRACT

Systems and methods are disclosed for displaying a digital model of a patient's teeth by determining interproximal information associated with each tooth; and annotating a graphical representation of the model of the tooth to provide a visual display of the interproximal information.

### BACKGROUND

The orthodontics industry is continuously developing new techniques for straightening teeth that are more comfortable and less detectable than traditional braces. One such technique has been the development of disposable and removable retainer-type appliances. As each appliance is replaced with the next, the teeth move a small amount until they reach the final alignment prescribed by the orthodontist or dentist. This sequence of dental aligners is currently marketed as the Invisalign® System by Align Technology, Inc., Santa Clara, Calif.

One problem experienced during treatment is a residual crowding of adjacent teeth due to insufficient interproximal reduction (IPR). This residual crowding can impede complete tooth alignment, and generally necessitates further abrasion reduction. Another problem is the occurrence of residual spaces between adjacent teeth due to excessive IPR. IPR represents a total amount of overlap between two teeth during a course of treatment. Such overlap must be treated by the clinician by removing material from the surface of the tooth. During the IPR procedure, a small amount of enamel thickness on the surfaces of the teeth is removed to reduce the mesiodistal width and space requirements for the tooth. The IPR procedure is also referred to as stripping, reproximation, and slenderizing. IPR is typically employed to create space for faster/easier-orthodontic treatment.

### SUMMARY

Systems and methods are disclosed for displaying a digital model of a patient's teeth by determining interproximal information associated with each tooth; and annotating a graphical representation of the model of the tooth to provide a visual display of the interproximal information.

Implementations of the invention may include one or more of the following. The interproximal information can be either interproximal reduction information or interproximal gap information. The interproximal information can include a content element and a link element. The content element can be a tooth identification, one or more treatment stages, and an interproximal distance, while the link element can be a line drawn to an interproximal region on the model of the tooth and that points to a three-dimensional area on the model of the tooth. An angle of rotation can be displayed with the graphical representation of the model of the tooth. A compass control can be associated with the angle of rotation. The computer receives a digital data set representing the patient's teeth and uses the data set to generate one or more orthodontic views of the patient's teeth. The system captures three-dimensional (3D) data associated with the patient's teeth; determines a viewpoint for the patient's teeth; applies a positional transformation to the 3D data based on the viewpoint; and rendering the orthodontic view of the patient's teeth based on the positional transformation. The system can generate a right buccal overjet view, an anterior overject view, a left buccal overjet view, a left distal molar view, a left lingual view, a lingual incisor view, a right lingual view and a right distal molar view of the patient's teeth. A 3D graphical representation of the teeth at the positions corresponding to a selected data set can be rendered. Alternatively, the 3D representation can be positioned at any arbitrary point in 3D space. The graphical representation of the teeth can be animated to provide a visual display of the movement of the teeth along the treatment paths. A level-of-detail compression can be applied to the selected data set to render the graphical representation of the teeth. A human user can modify the graphical representation of the teeth, which causes modifications to the selected data set in response to the instruction from the user. A graphical interface with components representing the control buttons on a video cassette recorder can be provided for a human user can manipulate to control the animation. A portion of the data in the selected data set can be used to render the graphical representation of the teeth. The human user can select a tooth in the graphical representation and read information about the tooth. The information can relate to the motion that the tooth will experience while moving along the treatment path. The graphical representation can render the teeth at a selected one of multiple viewing orthodontic-specific viewing angles. An input signal from a 2D input device such as a mouse or touch-screen, or alternatively a 3D gyroscopic input device controlled by a human user can be used to alter the orientation of the teeth in the graphical representation.

Advantages of the invention include one or more of the following. Visualization is used to communicate IPR treatment information in a computer-automated orthodontic treatment plan and appliance. The invention generates a realistic model of the patient's teeth without requiring a user to possess in-depth knowledge of parameters associated with a patient dental data capture system. Additionally, expertise in 3D software and knowledge of computer architecture is no longer needed to process and translate the captured medical data into a realistic computer model rendering and animation.

The invention thus allows IPR treatment visualization to be generated in a simple and efficient manner. It also improves the way a treating clinician performs case presentations by allowing the clinician to express his or her treatment plans more clearly. Another benefit is the ability to visualize and interact with models and processes without the attendant danger, impracticality, or significantly greater expense that would be encountered in the same environment if it were physical. Thus, money and time are saved while the quality of the treatment plan is enhanced.

### BRIEF DESCRIPTION OF THE DRAWINGS

FIG. 1 illustrates an exemplary user interface of a teeth viewer with interproximal information annotations.

FIG. 2 shows in more detail the interproximal annotation.

FIG. 3 illustrates an exemplary rotation of the teeth shown in FIG. 1

FIGS. 4A-4D show an exemplary process for providing and viewing inter-proximal information annotation.

### DESCRIPTION

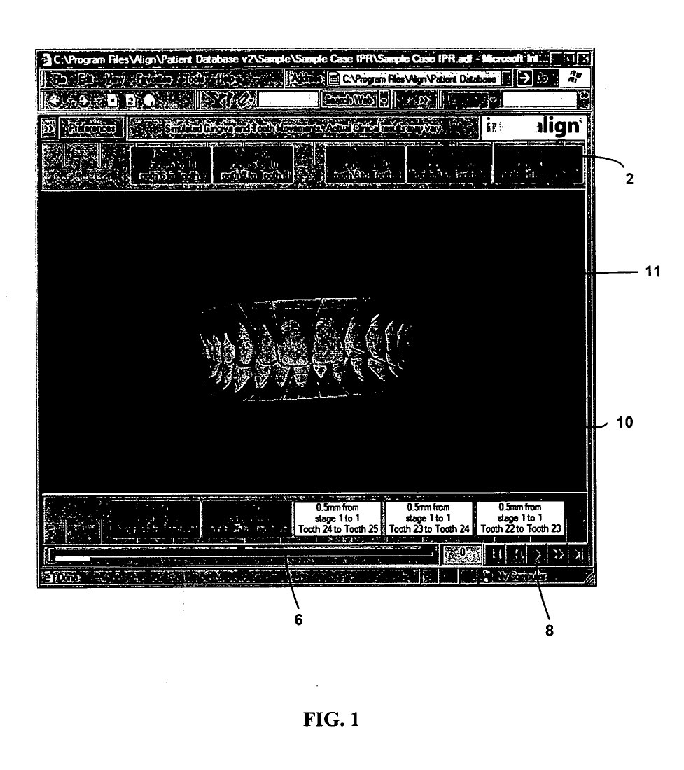

FIG. 1 shows an exemplary view with IPR annotations. The view is generated by a viewer program such as ClinCheck® software, available from Align Technology, Inc. of Santa Clara, Calif. As shown therein, an exemplary IPR annotation 2 is associated through a link 4 with a model of tooth 10. The annotation 2 indicates that there is a 0.3 mm overlap for teeth 10 and 11 between treatment stages 4-10. A visual indicator 6 is provided to indicate a current viewing position. The indicator 6 is referred to as a compass control because it is similar in function to a compass. Each compass control is associated with an angle of rotation. As the view of the scene rotates, so do the compass controls and any content therein. An easy way to visualize this is to imagine the compass control as an actual compass, with its north tracking the direction of the front teeth. In an IPR presentation, the orientation of the compass control 6 is determined by a minimum angle between the sagittal plane of the scene and the camera vector.

The viewer program also includes an animation routine that provides a series of images showing the positions of the teeth at each intermediate step along the treatment path. A user such as a clinician controls the animation routine through a VCR metaphor, which provides control buttons 8 similar to those on a conventional video cassette recorder. In particular, the VCR metaphor includes a “play” button that, when selected, causes the animation routine to step through all of the images along the treatment path. A slide bar can be used to request movement by a predetermined distance with each successive image displayed. The VCR metaphor also includes a “step forward” button and a “step back” button, which allow the clinician to step forward or backward through the series of images, one key frame or treatment step at a time, as well as a “fast forward” button and a “fast back” button, which allow the clinician to jump immediately to the final image or initial image, respectively. The clinician also can step immediately to any image in the series by typing in the stage number.

As described in commonly owned U.S. Pat. No. 6,227,850, the content of which is incorporated by reference, the viewer program receives a fixed subset of key positions, including an initial data set and a final data set, from the remote host. From this data, the animation routine derives the transformation curves required to display the teeth at the intermediate treatment steps, using any of a variety of mathematical techniques. One technique is by invoking the path-generation program described above. In this situation, the viewer program includes the path-generation program code. The animation routine invokes this code either when the downloaded key positions are first received or when the user invokes the animation routine.

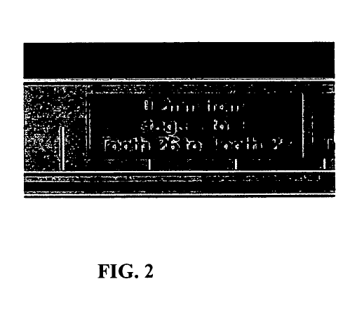

FIG. 2 shows a single IPR annotation 2 in more detail. For each IPR value there are two display components. The first is a content element on the compass control. This content element is placed on the compass control with an angle corresponding to the angle between the IPR region and the sagittal plane discussed above. The content consists of the IPR amount in millimeters, the stages during which the overlap occurs, and the tooth ID's for the adjacent teeth.

The second display element is a link element 4 shown in FIG. 1. In one embodiment, the link element is a line drawn from a 2D screen position adjacent to the first content element to the point in 3D space corresponding to the IPR region. This line is drawn in a later rendering pass than the rest of the scene. This ensures than no part of the scene can obscure the line. Whenever the camera is repositioned, a series of calculations are performed before the scene is redrawn. They occur in an undefined order.

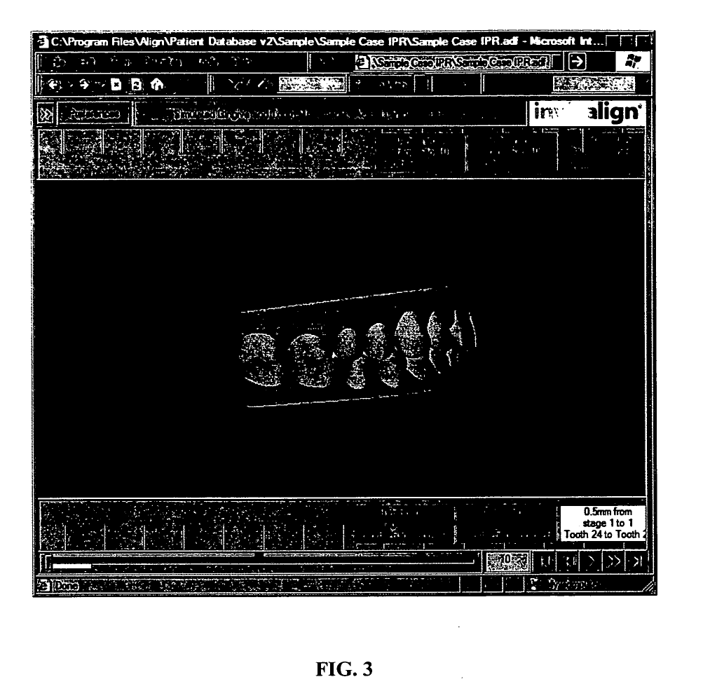

The angle between the sagittal plane and the camera is recalculated so that the compass control may show its proper orientation. When the camera is moved, the 2D to 3D line is ‘dirtied’ in a rendering sense. When it is therefore re-rendered, then and only then is the calculation performed to determine the 2D point. In addition to this dirtying operation, the pixel offsets for the compass control display elements are recalculated when the camera position is changed. The 3D scene coordinate is fixed and does not need to be recalculated. FIG. 3 shows the IPR presentation when a scene is rotated.

The viewer program displays an initial image of the teeth and, if requested by the clinician, a final image of the teeth as they will appear after treatment. The clinician can rotate the images in three dimensions to view the various tooth surfaces, and the clinician can snap the image to any of several predefined viewing angles. These viewing angles include the standard front, back, top, bottom and side views, as well as orthodontic-specific viewing angles, such as the lingual, buccal, facial, occlusal, and incisal views. The viewer program allows the clinician to alter the rendered image by manipulating the image graphically. For example, the clinician can reposition an individual tooth by using a mouse to click and drag or rotate the tooth to a desired position. In some implementations, repositioning an individual tooth alters only the rendered image; in other implementations, repositioning a tooth in this manner modifies the underlying data set. In the latter situation, the viewer program performs collision detection to determine whether the attempted alteration is valid and, if not, notifies the clinician immediately. Alternatively, the viewer program modifies the underlying data set and then uploads the altered data set to the remote host, which performs the collision detection algorithm. The clinician also can provide textual feedback to the remote host through a dialog box in the interface display. Text entered into the dialog box is stored as a text object and later uploaded to the remote host or, alternatively, is delivered to the remote host immediately via an existing connection.

The viewer program optionally allows the clinician to isolate the image of a particular tooth and view the tooth apart from the other teeth. The clinician also can change the color of an individual tooth or group of teeth in a single rendered image or across the series of images. These features give the clinician a better understanding of the behavior of individual teeth during the course of treatment. Another feature of the viewer program allows the clinician to receive information about a specific tooth or a specific part of the model upon command, e.g., by selecting the area of interest with a mouse. The types of information available include tooth type, distance between adjacent teeth, and forces (magnitudes and directions) exerted on the teeth by the aligner or by other teeth. Finite element analysis techniques are used to calculate the forces exerted on the teeth. The clinician also can request graphical displays of certain information, such as a plot of the forces exerted on a tooth throughout the course of treatment or a chart showing the movements that a tooth will make between steps on the treatment path. The viewer program also optionally includes “virtual calipers,” a graphical tool that allows the clinician to select two points on the rendered image and receive a display indicating the distance between the points.

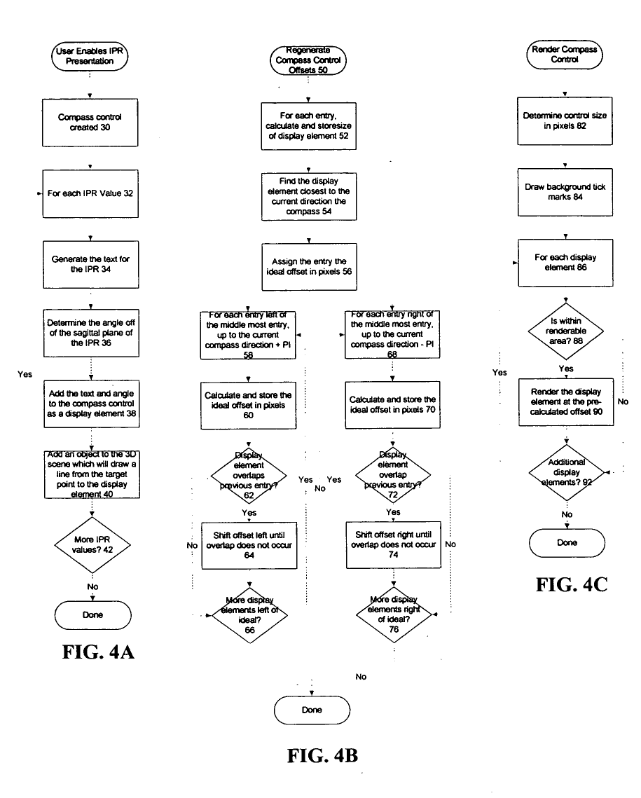

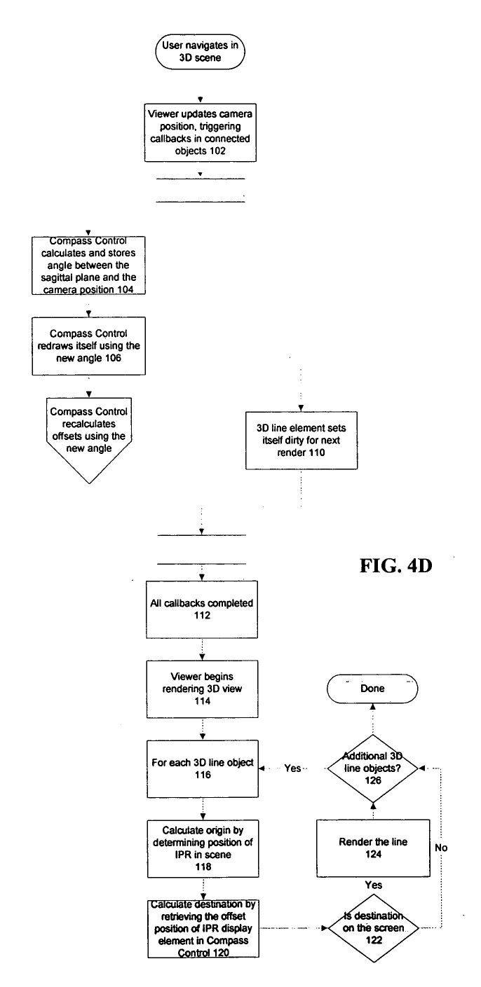

FIG. 4A shows an exemplary process for providing IPR information annotation. When the user enables IPR annotation viewing or presentation, a compass control is create (30). Next, for each IPR value (32), the process generates the text for the IPR (34). The process also determines the angle off of the sagittal plane of the IPR (36). The text and angle information is added to the compass control as a display element (38). In 38, the adding of a display element to the compass control triggers the sub-process of recalculating the pixel offsets for each display element. Other events that triggers such a recalculation is changing the current angle of the compass control, as indicated with the off page reference, or a resizing of the control, among others. An object is also added to the 3D scene which will draw a line from a target point to the display element (40). Next, the process checks whether additional IPR data needs to be processed (42). If more IPR data remains, the process loops back to 32, and otherwise the process exits.

Turning now to FIG. 4B, from 38 (FIG. 4A), the process regenerates the compass control offsets (50). For each entry, the process calculates and stores the size of the display elements (52). Next, the process finds the display element closes to the current direction of the compass (54). The entry is assigned the ideal offset in pixels (56).

The compass control is associated with a number of static display elements, each of which is associated with 2 values: a size value (relating to the text width) and a display angle value. During the recalculation of pixel offsets, the compass control determines the first the ideal pixel offset from the center of the control for the center of the display element. For instance, if the angle of the compass was 180 degrees, and the compass control was trying to render a display element at 180 degrees, the ideal pixel offset is 0 because the display element should be perfectly centered. If the compass is at 185 degrees, then the pixel offset is going to be a small number indicating that the display element should be drawn left of the center. When only one display element is on a compass this is all the calculation that needs to occur. However, if there is more than one element, it is possible that the display elements would overlap if both drawn at their ideal offsets. Therefore, starting with the centermost display element, that is, the one with the smallest absolute value for its ideal pixel offset, each display element has its pixel offset increased (or decreased depending on direction) until the overlap does not occur. Once all calculations are done, the pixel offsets are stored with each display element. They are then referenced when the compass control is rendering itself so that each display element can be placed.

For each entry left of the middle most entry up to the current compass direction and π (58), the process calculates and stores the ideal offset in pixels (60). The process checks whether the display elements overlaps the previous entry (62). If so, the process shifts the offset left until the overlap disappears (64). From (62) or (64), the process checks whether additional display elements are left of the ideal offset (66). If so, the process loops back to 58. Otherwise, the process continues on for each entry right of the middle most entry up to the current compass direction—π (68), the process calculates and stores the ideal offset in pixels (70). The process checks whether the display elements overlaps the previous entry (72). If so, the process shifts the offset left until the overlap disappears (74). From (72) or (74), the process checks whether additional display elements are right of the ideal offset (76). If so, the process loops back to 68. Otherwise, the process exits.

Turning now to FIG. 4C, an exemplary process to render compass control is shown. First, the process determines a control size in pixels (82). Next, background tick marks are drawn (84). For each display element (86), the process checks if the display element is in a renderable area (88). If so, the display element is rendered at the pre-calculated offset (90). From 88 or 90, the process checks whether additional display elements remain (92). If so, the process loops back to 86 and otherwise the process exits.

Referring now to FIG. 4D, an exemplary process for user navigation with the 3D scene is shown. First, the view updates camera position (102). This triggers two parallel forks. In the first fork, the compass control calculates and stores the angle between the sagittal plane and the camera position (104). Next, the compass control redraws itself using the newly determined angle (106). Further, the compass control recalculates off-sets using the new angle by jumping to 50 (FIG. 4B). In the second fork, the 3D line element sets itself as ‘dirty’ in order for the line element to be rendered (110).

In 112, all call-backs are completed, and the viewer begins rendering a 3D view (114). For each 3D line object (116), the process determines origin by determining position of the IPR in the scene (118). The process also computes the destination by retrieving the offset position of the IPR display element in the compass control (120). Next, the process checks whether the destination is on the screen (122). If so, it renders the line. From 122 or 124, the process checks whether additional 3D line objects remain (126). If so, it loops back to 116 and if not, the process exits.

At some point after the compass control recalculates its offsets, the windows control will be re-rendered. Since the control is a windows control and not a 3D rendering context, its rendering is not tied to the rendering of the 3D view, though in practice the mechanisms that cause one to re-render will also indirectly trigger a re-render of the other.

A simplified block diagram of a data processing system that may be used to develop orthodontic treatment plans is discussed next. The data processing system typically includes at least one processor which communicates with a number of peripheral devices via bus subsystem. These peripheral devices typically include a storage subsystem (memory subsystem and file storage subsystem), a set of user interface input and output devices, and an interface to outside networks, including the public switched telephone network. This interface is shown schematically as “Modems and Network Interface” block, and is coupled to corresponding interface devices in other data processing systems via communication network interface. Data processing system could be a terminal or a low-end personal computer or a high-end personal computer, workstation or mainframe.

The user interface input devices typically include a keyboard and may further include a pointing device and a scanner. The pointing device may be an indirect pointing device such as a mouse, trackball, touchpad, or graphics tablet, or a direct pointing device such as a touch-screen incorporated into the display, or a three dimensional pointing device, such as the gyroscopic pointing device described in U.S. Pat. No. 5,440,326, other types of user interface input devices, such as voice recognition systems, can also be used.

User interface output devices typically include a printer and a display subsystem, which includes a display controller and a display device coupled to the controller. The display device may be a cathode ray tube (CRT), a flat-panel device such as a liquid crystal display (LCD), or a projection device. The display subsystem may also provide non-visual display such as audio output.

Storage subsystem maintains the basic required programming and data constructs. The program modules discussed above are typically stored in storage subsystem. Storage subsystem typically comprises memory subsystem and file storage subsystem.

Memory subsystem typically includes a number of memories including a main random access memory (RAM) for storage of instructions and data during program execution and a read only memory (ROM) in which fixed instructions are stored. In the case of Macintosh-compatible personal computers the ROM would include portions of the operating system; in the case of IBM-compatible personal computers, this would include the BIOS (basic input/output system).

File storage subsystem provides persistent (non-volatile) storage for program and data files, and typically includes at least one hard disk drive and at least one floppy disk drive (with associated removable media). There may also be other devices such as a CD-ROM drive and optical drives (all with their associated removable media). Additionally, the system may include drives of the type with removable media cartridges. The removable media cartridges may, for example be hard disk cartridges, such as those marketed by Syquest and others, and flexible disk cartridges, such as those marketed by Iomega. One or more of the drives may be located at a remote location, such as in a server on a local area network or at a site on the Internet's World Wide Web.

In this context, the term-“bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Similarly, the input devices and display need not be at the same location as the processor, although it is anticipated that personal computers and workstations typically will be used.

Bus subsystem is shown schematically as a single bus, but a typical system has a number of buses such as a local bus and one or more expansion buses (e.g., ADB, SCSI, ISA, EISA, MCA, NuBus, or PCI), as well as serial and parallel ports. Network connections are usually established through a device such as a network adapter on one of these expansion buses or a modem on a serial port. The client computer may be a desktop system or a portable system.

Scanner is responsible for scanning casts of the patient's teeth obtained either from the patient or from an orthodontist and providing the scanned digital data set information to data processing system for further processing. In a distributed environment, scanner may be located at a remote location and communicate scanned digital data set information to data processing system via network interface.

Fabrication machine fabricates dental appliances based on intermediate and final data set information received from data processing system. In a distributed environment, fabrication machine may be located at a remote location and receive data set information from data processing system via network interface.

The invention has been described in terms of particular embodiments. Other embodiments are within the scope of the following claims. For example, the system can show IPRs as well as interproximal gaps, or spaces that appear between adjacent teeth in the dental arches.

1. A method for displaying a digital model of a patient's teeth, comprising:
determining interproximal information associated with each tooth; and
annotating a graphical representation of the model of the tooth to provide a visual display of the interproximal information.

2. The method of claim 1, wherein the interproximal information comprises interproximal reduction information or interproximal gap information.

3. The method of claim 1, wherein the interproximal information comprises a content element and a link element.

4. The method of claim 3, wherein the content element comprises of a tooth identification, one or more treatment stages, and an interproximal distance.

5. The method of claim 3, wherein the link element comprises a line drawn to an interproximal region on the model of the tooth.

6. The method of claim 1, wherein the line points to a three-dimensional area on the model of the tooth.

7. The method of claim 1, comprising displaying an angle of rotation with the graphical representation of the model of the tooth.

8. The method of claim 7, comprising displaying a compass control associated with the angle of rotation.

9. The method of claim 1, comprising
determining a treatment path for each tooth; and
updating the graphical representation of the teeth to provide a visual display of the position of the teeth along the treatment paths.

10. The method of claim 1, comprising:
determining a viewpoint for the teeth model;
applying a positional transformation to the 3D data based on the viewpoint; and
rendering a graphical representation of the teeth model based on the positional transformation.

11. The method of claim 1, comprising generating one of: a right buccal overjet view of the patient's teeth, an anterior overject view of the patient's teeth, a left buccal overjet view of the patient's teeth, a left distal molar view of the patient's teeth, a left lingual view of the patient's teeth, a lingual incisor view of the patient's teeth, a right lingual view of the patient's teeth, and a right distal molar view of the patient's teeth.

12. The method of claim 1, comprising rendering a 3D graphical representation of the teeth at the positions corresponding to a selected data set.

13. The method of claim 1, comprising receiving an instruction from a human user to modify the graphical representation of the teeth.

14. The method of claim 13, comprising modifying the selected data set in response to the instruction from the user.

15. The method of claim 1, comprising providing a graphical interface, with components representing the control buttons on a video cassette recorder, which a human user can manipulate to control the animation.

16. The method of claim 1, comprising allowing a human user to select a tooth in the graphical representation and, in response, displaying information about the tooth.

17. The method of claim 16, wherein the information relates to the motion that the tooth will experience while moving along the treatment path.

18. The method of claim 1, comprising rendering the teeth at a selected one of multiple viewing orthodontic-specific viewing angles.

19. The method of claim 1, comprising receiving an input signal from a 3D gyroscopic input device controlled by a human user and using the input signal to alter the orientation of the teeth in the graphical representation.

20. A system for displaying a digital model of a patient's teeth, comprising:
means for determining interproximal information associated with each tooth; and
means for annotating a graphical representation of the model of the tooth to provide a visual display of the interproximal information.
